(19) United States
(12) Patent Application Publication
(10) Pub. No.: US 2023/0020824 A1
(43) Pub. Date: Jan. 19, 2023

(54) HEATING, VENTILATION, AND AIR-CONDITIONING SYSTEM AND METHOD OF CONTROLLING A HEATING, VENTILATION, AND AIR-CONDITIONING SYSTEM

(71) Applicant: Robert Bosch GmbH, Stuttgart (DE)

(72) Inventors: Manish Gupta, Singapore (SG); Baris Tanyildiz, Singapore (SG); Fabrizio Cola, Singapore (SG)

(21) Appl. No.: 17/858,705

(22) Filed: Jul. 6, 2022

(30) Foreign Application Priority Data
Jul. 12, 2021 (EP) 21 18 4965.8

(51) Int. Cl. F24F 11/63; G05B 19/042

(52) U.S. Cl. CPC F24F 11/63; G05B 19/042; G05B 2219/2614

(57) ABSTRACT

A heating, ventilation, and air-conditioning, HVAC, system and a method of controlling a HVAC system, The method includes: successively for at least two HVAC devices of a plurality of HVAC devices: controlling the HVAC device in accordance with a set target temperature value which is different from an environmental temperature value, wherein the other HVAC devices of the plurality of HVAC devices are deactivated or running with unvarying running parameters, and for at least two environmental sensors of a plurality of environmental sensors, determining whether environmental parameters detected by the environmental sensor change; correlating at least one environmental sensor to the HVAC devices for which a change of the environmental parameters is determined; and controlling the HVAC system to change at least one environmental parameter associated with the at least one environmental sensor using the HVAC devices correlated with the at least one environmental sensor.

### CROSS REFERENCE

The present application claims the benefit under 35 U.S.C. § 119 of European Patent Application No. EP 21 18 4965.8 filed on Jul. 12, 2021, which is expressly incorporated herein by reference in its entirety.

### FIELD

Various aspects of the present invention relate to a heating, ventilation, and air-conditioning, HVAC system and a method of controlling a HVAC system.

### BACKGROUND INFORMATION

A heating, ventilation, and air-conditioning, HVAC, system may be employed to control an indoor environment (e.g., in a building, e.g., in a vehicle, etc.) to provide a thermal comfort and a desired indoor air quality. For this purpose, several HVAC devices, which are capable to change environmental parameters (e.g., a temperature, e.g., a humidity, etc.) may be distributed in the indoor environment. However, in order to control the environmental parameters of each region or zone of the indoor environment individually, it is necessary to determine which HVAC device(s) effects the environmental parameters within the respective region or zone. This correlation between HVAC devices and the regions or zones may be done manually, but this may require additional manpower and has the risk of human errors leading to wrong and/or incomplete correlations, which may lead to an erroneous control of the HVAC system. Hence, it may be advantageously to provide a method to more precisely correlate HVAC devices and regions or zones in an indoor environment and a HVAC system which is capable to carry out the method.

### SUMMARY

Various embodiments of the present invention relate to a method of controlling a heating, ventilation, and air-conditioning, HVAC, system, the method including: successively for at least two HVAC devices of a plurality of HVAC devices associated with the HVAC system: controlling the HVAC device in accordance with a set target HVAC temperature value which is different from an environmental temperature value, wherein the other HVAC devices of the plurality of HVAC devices are deactivated or running with unvarying running parameters, and for at least two environmental sensors of a plurality of environmental sensors (e.g., associated with the HVAC system and/or another system, such as a Smart Home System), determining whether one or more environmental parameters detected by the respective environmental sensor change; for at least one environmental sensor of the at least two environmental sensors, correlating the at least one environmental sensor to the HVAC devices of the at least two HVAC devices for which a change of the one or more environmental parameters is determined; and controlling the HVAC system to change at least one environmental parameter associated with the at least one environmental sensor using the HVAC devices of the at least two HVAC devices correlated with the at least one environmental sensor.

According to various embodiments of the present invention, running the other HVAC devices of the plurality of HVAC devices with unvarying running parameters may include maintaining respective running parameters of each of the plurality of HVAC devices constant except for the HVAC device which is controlled to change the environmental temperature.

According to various embodiments of the present invention, the one or more environmental parameters may include one or more of a temperature, a humidity, and/or a dew point.

According to various embodiments of the present invention, the HVAC system may include a variable refrigerant flow system and/or a chiller system.

According to various embodiments of the present invention, determining whether one or more environmental parameters detected by the respective environmental sensor change may include: the environmental sensor detecting a temperature gradient value while the HVAC device is controlled in accordance with the set target HVAC temperature.

According to various embodiments of the present invention, the method may further include for each HVAC device of the at least two HVAC devices, determining a respective weight value for each environmental sensor correlated with the HVAC device using the temperature gradient values detected by the environmental sensors correlated with the HVAC device.

According to various embodiments of the present invention, the weight value associated with an environmental sensor correlated with the HVAC device is determined as a fraction of the temperature gradient value detected by the environmental sensor from all temperature gradient values that are detected by the environmental sensors correlated with the HVAC device.

According to various embodiments of the present invention, controlling the HVAC system to change at least one environmental parameter associated with the at least one environmental sensor of the at least two environmental sensors using the HVAC devices of the at least two HVAC devices correlated with the at least one environmental sensor may include: controlling the HVAC system to change at least one environmental parameter associated with the at least one environmental sensor using the HVAC devices correlated with the at least one environmental sensor (e.g., two or more HVAC devices may be correlated with the at least one environmental sensor) and their respective weight value determined for the at least one environmental sensor.

According to various embodiments of the present invention, controlling the HVAC system to change at least one environmental parameter associated with the at least one environmental sensor of the at least two environmental sensors using the HVAC devices of the at least two HVAC devices correlated with the at least one environmental sensor may include: controlling the HVAC system to change at least one environmental parameter associated with the at least one environmental sensor of the at least two environmental sensors using the HVAC devices correlated with the at least one environmental sensor and occupancy information, the occupancy information describing an occupancy of a region in which the HVAC devices correlated with the at least one environmental sensor are located.

Various embodiments of the present invention relate to a heating, ventilation, and air-conditioning, HVAC, system, the HVAC system including: a plurality of HVAC devices, wherein each of the plurality of HVAC devices is configured to change an environmental temperature in accordance with a respective set target HVAC temperature; a plurality of environmental sensors, wherein each of the plurality of environmental sensors is configured to detect one or more environmental parameters; and a control device configured to control the plurality of HVAC devices and the plurality of environmental sensors and to carry out the method of controlling a HVAC system according to one or more of the above described embodiments. According to various embodiments, at least one (e.g., each) environmental sensor of the plurality of environmental sensors is configured to wirelessly transmit the detected one or more environmental parameters to the control device.

### BRIEF DESCRIPTION OF THE DRAWINGS

The present invention may be better understood with reference to the detailed description when considered in conjunction with the non-limiting examples and the figures.

FIG. 1 shows exemplary HVAC system according to various embodiments of the present invention.

FIG. 2, FIG. 3A, FIG. 3B, and FIG. 4 each show a flow diagram of a method of controlling a HVAC system according to various embodiments of the present invention.

FIG. 5B shows an exemplary mapping of HVAC devices to environmental sensors according to various embodiments of the present invention.

FIG. 5A and FIG. 6 each show an exemplary HVAC system of the present invention.

### DETAILED DESCRIPTION OF EXAMPLE EMBODIMENTS

The following detailed description refers to the figures that show, by way of illustration, specific details and embodiments in which the present invention may be practiced. These embodiments are described in sufficient detail to enable those skilled in the art to practice the present invention. Other embodiments may be utilized and structural, and logical changes may be made without departing from the scope of the present invention. The various embodiments are not necessarily mutually exclusive, as some embodiments can be combined with one or more other embodiments to form new embodiments.

Embodiments described in the context of one of the HVAC systems or methods are analogously valid for the other enclosure HVAC systems or methods. Similarly, embodiments described in the context of a HVAC system are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

While the present invention has been particularly shown and described with reference to specific embodiments, it should be understood by those skilled in the art that various changes in form and detail may be made therein without departing from the spirit and scope of the present invention.

To control a heating, ventilation, and air-conditioning, HVAC, system efficiently, it is necessary to know which HVAC device influences which region of an indoor environment (e.g., in a building, e.g., in a vehicle, etc.). Various aspects relate to a HVAC system and a method of controlling a HVAC system which are capable to map HVAC devices to regions in an indoor environment by correlating the HVAC devices with environmental sensors within the indoor environment.

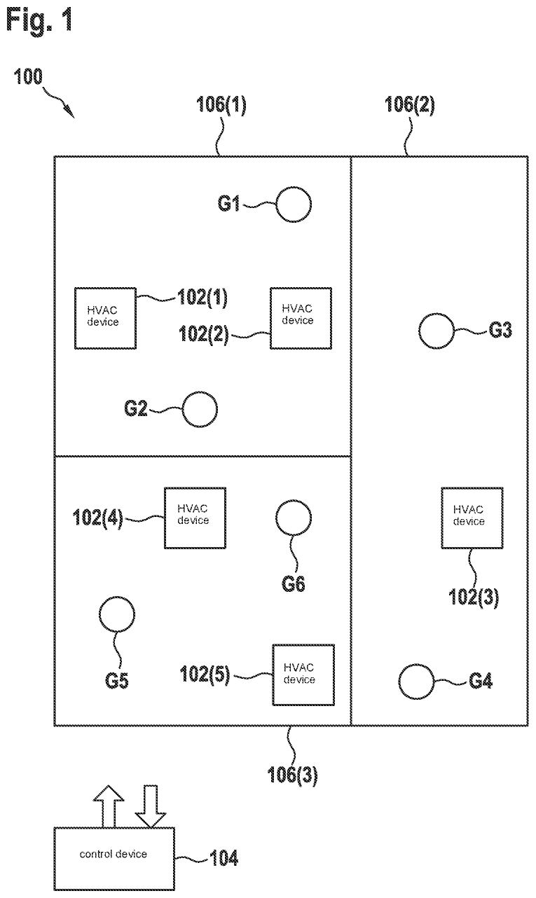

FIG. 1 shows an exemplary HVAC system 100 according to various embodiments.

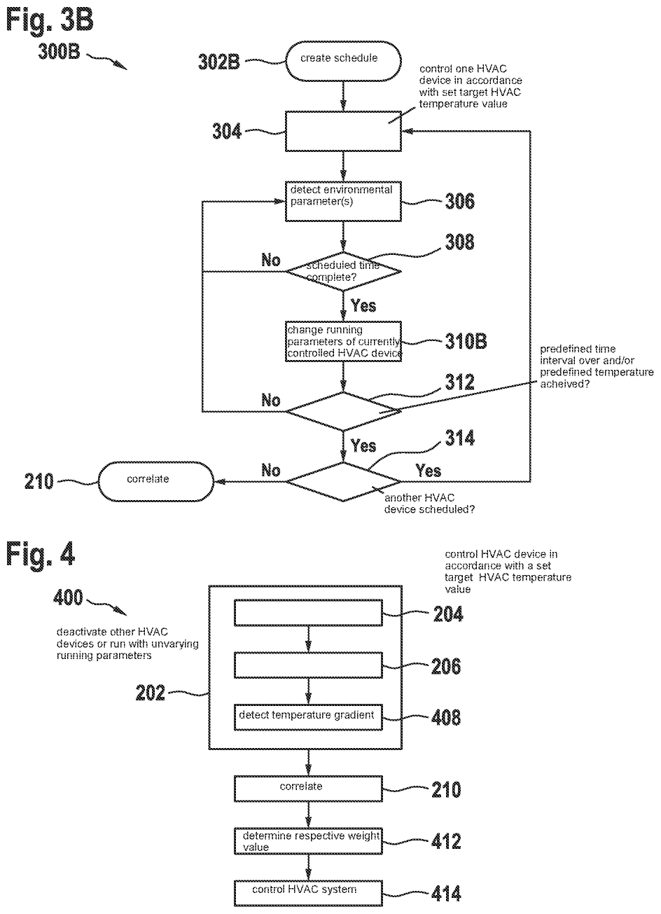

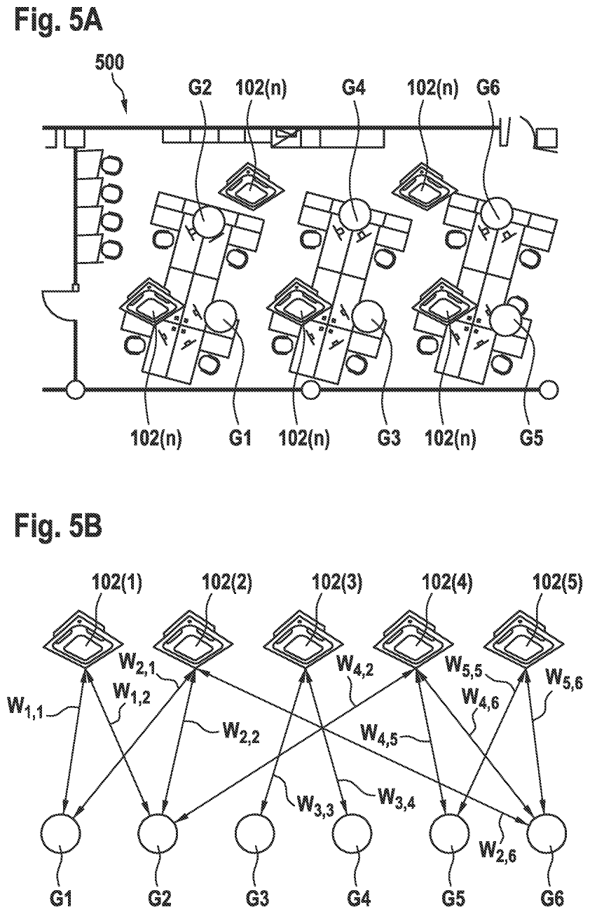

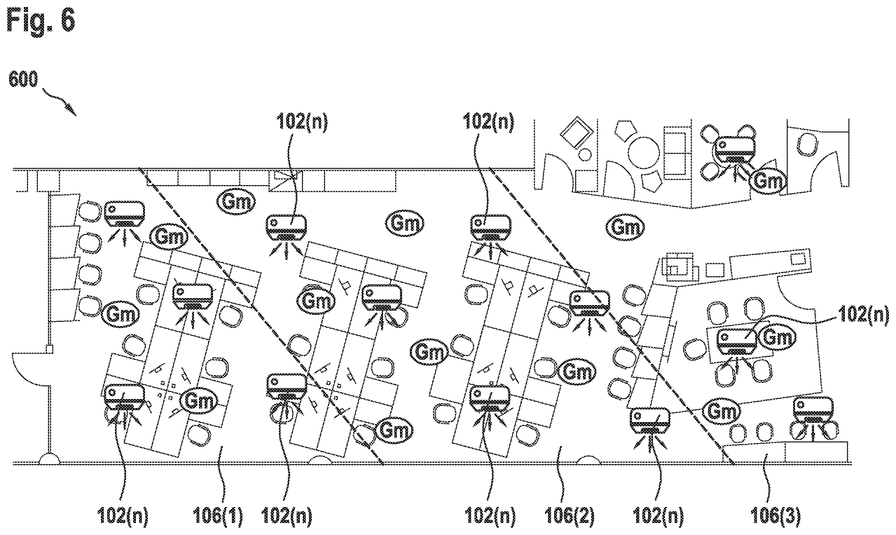

The HVAC system 100 may include a plurality of HVAC devices 102(n=1 to N). N may be any integer number equal to or greater than two. A HVAC device as used herein may be any kind of device capable to change environmental conditions in a surrounding of the device. For example, the HVAC system 100 may be or may include a Variable Refrigerant Flow (VRF) system (see, for example, FIG. 5A). In this case, a HVAC device may be an indoor VRF unit of the VRF system. For example, the HVAC system may be or may include a chiller system (see, for example, FIG. 6). In this case, a HVAC device may be a chiller unit of the chiller system. According to various aspects, the HVAC system may be or may include a VRF system and a chiller system. In this case, the HVAC system may include VRF units and chiller units as HVAC devices.

Each HVAC device 102(n) of the plurality of HVAC devices 102(n=1 to N) may be configured to change one or more environmental parameters in accordance with set target parameters. According to various aspects, each HVAC device 102(n) of the plurality of HVAC devices 102(n=1 to N) may be configured to change an environmental temperature (in some aspects also referred to as environment temperature) in accordance with a respective set target HVAC temperature (e.g., 22 C or any other temperature which is different from a current environmental temperature (e.g., room temperature)). Illustratively, each HVAC device 102(n) may be set to a target HVAC temperature and may be configured to change the environmental temperature in the surrounding of the HVAC device to reach the set target HVAC temperature.

The HVAC system 100 may include and/or may communicate with a plurality of environmental sensors Gm (with m=1 to M). M may be any integer number equal to or greater than two. Each environmental sensor Gm of the plurality of environmental sensors may be configured to detect one or more environmental parameters. Each environmental sensor Gm of the plurality of environmental sensors may be configured to detect the one or more environmental parameters in a surrounding of the respective environmental sensor. An environmental parameter of the one or more environmental parameters may be, for example, a temperature, a humidity, or a dew point. For example, the HVAC system 100 may include each environmental sensor of the plurality of environmental sensors Gm. For example, a Smart Home System may include each environmental sensor of the plurality of environmental sensors Gm. For example, the Smart Home System may include some environmental sensors of the plurality of environmental sensors Gm and the HVAC system 100 may include some (e.g., the other) environmental sensors of the plurality of environmental sensors Gm. The Smart Home System may be communicatively coupled to the HVAC system 100 (e.g., to transmit the one or more environmental parameters detected by an environmental sensor to the HVAC system 100). For example, one or more environmental sensors of the plurality of environmental sensors Gm may be part of other electrical products, such as a TV, a receiver, a washing machine, an oven, or the like.

The HVAC system 100 may include a control device 104 (e.g., including one or more processors). The control device 104 may be configured to control the plurality of HVAC devices 102(n). For example, the control device 104 may be configured to set the respective target HVAC temperature of each HVAC device. The control device 104 may be configured to control the HVAC system 100 (e.g., employing the plurality of HVAC devices 102(n)) to change environmental parameters within the indoor environment. The control device 104 may be configured to communicate with each environmental sensor Gm of the plurality of environmental sensors. For example, each environmental sensor Gm may be configured to provide (e.g., transmit) the detected one or more environmental parameters to the control device 104. For example, the control device 104 and the HVAC devices may be part of the same system (e.g., integrated) and the control device 104 may receive the data representing the detected one or more environmental parameters from each environmental sensor. For example, the HVAC devices may be part of a building management system and the control device 104 may be configured to communicate (e.g., via an open source protocol, such as BacNet/Modbus) with the building management system to receive the data representing the detected one or more environmental parameters of each environmental sensor. The data acquired by the control device 104 may be stored in a local memory and/or in a cloud memory.

According to various aspects, an environmental sensor Gm of the plurality of environmental sensors may be a wireless sensor. Illustratively, an environmental sensor Gm of the plurality of environmental sensors may be configured to wirelessly transmit (e.g., via Bluetooth, e.g., via Wireless Fidelity, etc.) the detected one or more environmental parameters (e.g., data representing the detected one or more environmental parameters). Each environmental sensor Gm of the plurality of environmental sensors may be configured to wirelessly transmit the detected one or more environmental parameters to the control device 104.

At least one environmental sensor (e.g., each environmental sensor) of the plurality of environmental sensors may be as associated with an internet-of-things (IOT) Gateway. For example, the HVAC system 100 may include a plurality of IOT Gateways. At least one (e.g., each) IOT Gateway may be configured to receive respective sensor data from one or more sensors associated with the IOT Gateway and may be configured to transmit the received sensor data to the control device 104. At least one (e.g., each) IOT Gateway may be configured to receive respectively detected environmental parameters from one or more environmental sensors of the plurality of environmental sensors. According to various aspects, the plurality of IOT Gateways may communicate with each other via a mesh network. Illustratively, the plurality of IOT Gateways may form (e.g., create) a mesh network. According to various aspects, one or more (e.g., all) of the IOT Gateways may be configured to receive an occupancy sensor configured to detect occupancy information which describe an occupancy of a region (e.g., a zone). According to various aspects, the HVAC system 100 may include a first group of IOT Gateways associated with the environmental sensors and a second group of IOT Gateways associated with the occupancy sensors.

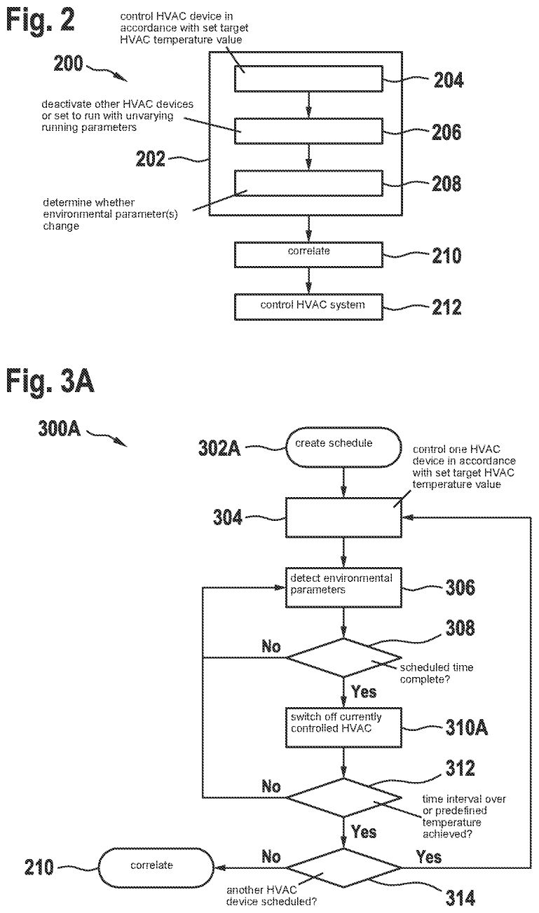

The HVAC system 100 may be associated with an indoor environment. The indoor environment may include a plurality of zones (e.g., regions within the indoor environment). For example, a zone of the plurality of zones associated with the HVAC system 100 may be a room within the indoor environment. As illustrative examples, FIG. 1 shows a first zone 106(1), a second zone 106(2), and a third zone 106(3). For example, a floor plan of the indoor environment (e.g., a building) may include the plurality of zones, the respective position of each HVAC device 102(n) of the plurality of HVAC devices, and the respective position of each environmental sensor Gm of the plurality of environmental sensors. However, the indoor environment may include several zones within the same room and in order to control the environmental conditions within the indoor environment it is necessary to determine which HVAC device 102(n) effects which zone(s) or even which sub-regions of a zone. Various methods of controlling a HVAC system, such as the HVAC system 100, capable to correlate with the plurality of HVAC devices and the plurality of environmental sensors are described with reference to FIG. 2, FIG. 3A, and FIG. 3B. The environmental conditions within a zone may be changed by more than one HVAC device 102(n) of the plurality of HVAC devices. However, the HVAC devices which influence the environmental conditions of the same zone may have a different impact on the environmental conditions within the zone. Various methods of controlling a HVAC system, such as the HVAC system 100, capable to determine a respective impact of each HVAC device of the plurality of HVAC devices on each environmental sensor of the plurality of environmental sensors are described with reference to FIG. 4 and FIG. 5B.

FIG. 2 shows a flow diagram of a method 200 of controlling a HVAC system, such as the HVAC system 100. The method 200 may (in 202) include successively for each of at least two HVAC devices (e.g., two HVAC devices, e.g., three HVAC devices, e.g., more than three HVAC devices) of a plurality of HVAC devices (e.g., two HVAC devices, e.g., three HVAC devices, e.g., more than three HVAC devices) associated with the HVAC system: controlling the HVAC device in accordance with a set target HVAC temperature value which is different from an environmental temperature (in 204). A number of HVAC devices of the plurality of HVAC devices may be equal to or greater than a number of HVAC devices of the at least two HVAC devices. In the case that the number of HVAC devices of the plurality of HVAC devices is equal to the number of HVAC devices of the at least two HVAC devices, the method 200 may (in 202) be carried out successively for each HVAC device of the plurality of HVAC devices. The other HVAC devices of the plurality of HVAC devices may be deactivated (e.g., switched off) or may run with unvarying running parameters. For example, current running parameters of the other HVAC devices may be maintained constant. The other HVAC devices of the plurality of HVAC devices may be deactivated or set to run with unvarying running parameters prior to controlling the HVAC device in accordance with the set target HVAC temperature value or afterwards (e.g., in 206). Running parameters of a HVAC device, as used herein, may be any kind of parameters associated with changing environmental conditions, such as a fan speed, a valve opening (e.g., of a valve for controlling a flow of a cooling liquid, such as a throughput of cooling water), etc. The method 200 may include, for at least two environmental sensors (e.g., for each environmental sensor) of a plurality of environmental sensors, determining whether one or more environmental parameters detected by the environmental sensor change (in 208).

According to various aspects, the HVAC system 100 may be configured to carry out the method. In this case, the control device 104 may be configured to control each HVAC device, such as setting the target HVAC temperature, deactivating the HVAC device, or set the HVAC device to unvarying running parameters.

Each environmental parameter Gm of the HVAC system 100 may be configured to transmit the detected one or more environmental parameters to the control device 104 and the control device 104 may be configured to determine for each environmental sensor whether the detected one or more environmental parameters change.

The method 200 may include, for at least one (e.g., each) environmental sensor of the at least two environmental sensors (e.g., each of the plurality of environmental sensors), correlating the environmental sensor to the HVAC devices of the at least two HVAC devices (e.g., to the HVAC devices of the plurality of HVAC devices) for which a change of the one or more environmental parameters is determined (in 210). Illustratively, correlating the environmental sensor to the HVAC devices for which a change of the one or more environmental parameters is determined provides a mapping of environmental sensors to HVAC devices which impact a respective environmental sensor as well as a mapping of each HVAC device to the environmental sensors which are effected by the respective HVAC device. According to various aspects, the HVAC system 100 may be configured to carry out the method and an illustrative example of a correlation between each environmental sensor Gm and the plurality of HVAC devices is exemplarily shown in the following table 1, wherein “0” denotes no impact and “1” denotes that environmental conditions in the surrounding of the respective environmental sensor are changed by the respective HVAC device; table 1:

| | G1 | G2 | G3 | G4 | G5 | G6 |
|---|---|---|---|---|---|---|
| 102(1) | 1 | 1 | 0 | 0 | 0 | 0 |
| 102(2) | 1 | 1 | 0 | 0 | 0 | 1 |
| 102(3) | 0 | 0 | 1 | 1 | 0 | 0 |
| 102(4) | 0 | 1 | 0 | 0 | 1 | 1 |
| 102(5) | 0 | 0 | 0 | 0 | 1 | 1 |

The method may include controlling the HVAC system to change at least one environmental parameter associated with at least one environmental sensor of the plurality of environmental sensors using the HVAC devices (e.g., the HVAC devices of the at least two HVAC devices or the HVAC devices of the plurality of HVAC devices correlated with the at least one environmental sensor (in 212). According to various aspects, the HVAC system 100 may be configured to carry out the method and control device 104 may be configured to control at least one environmental parameter (e.g., a temperature) of the environmental sensor G6 using the HVAC devices 102(2), 102(4), and 102(5) correlated with the environmental sensor G6. As another example, the control device 104 may control at least one environmental parameter of the environmental sensor G1 and of the environmental sensor G2 using the HVAC devices 102(1), 102(2), and 102(4) correlated with the environmental sensors G1 and/or G2.

As described herein with reference to FIG. 2, the other HVAC devices except for the HVAC device which is controlled to change the environmental temperature may be either deactivated (e.g., switched off) or may run with unvarying running parameters.

FIG. 3A shows a flow diagram 300A of a method of controlling a HVAC system according to various embodiments, wherein the other HVAC devices are switched off. FIG. 3B shows a flow diagram 300B of a method of controlling a HVAC system according to various embodiments, wherein the other HVAC devices are running with unvarying running parameters. According to various aspects, the methods described with reference to FIG. 3A and FIG. 3B may be carried out as part of the method described with reference to FIG. 2 (e.g., in or as part of 202).

With reference to FIG. 3A, the method may include creating a schedule to turn on one HVAC device and turn off the other HVAC devices sequentially (in 302A). The method may include controlling one of the HVAC devices in accordance with a set target HVAC temperature value which is different from an environmental temperature (in 304). The method may include each environmental sensor of the plurality of environmental sensors detecting respective one or more environmental parameters (in 306). The method may include determining whether a scheduled time (e.g., 15 min, e.g., 30 min, e.g., a time in the range from about 15 min to about 30 min, etc.) is complete or not (in 308). In the case, that the scheduled time is not complete (“No” in 308), the method may include that the plurality of environmental sensors continues detecting respective one or more environmental parameters. In the case, that the scheduled time is complete (“Yes” in 308), the method may include switching off the currently controlled HVAC device (in 310A). The method may also include a predefined time interval (e.g., a time in the range from about 15 min to about 30 min) to wait for the HVAC devices to cool down and/or an interval waiting for the HVAC devices to reach a predefined temperature. The method may include determining whether the predefined time interval is over and/or whether the predefined temperature is achieved (in 312). In the case, that the predefined time interval is not over and/or the predefined temperature is not achieved (“No” in 312), the method may include that the plurality of environmental sensors continues detecting respective one or more environmental parameters. In the case, that the predefined time interval is over and/or the predefined temperature is achieved (“Yes” in 312), the method may include determining whether another HVAC device of the plurality of HVAC devices is scheduled to be controlled in accordance with a set target HVAC temperature value (in 314). In the case that another HVAC device of the plurality of HVAC devices is scheduled to be controlled in accordance with a set target HVAC temperature value (“Yes” in 314), the method may include controlling the other HVAC device in accordance with the set target HVAC temperature value (in 304). In the case that no other HVAC device of the plurality of HVAC devices is scheduled to be controlled in accordance with a set target HVAC temperature value (“No” in 314), the method may include, for each environmental sensor of the plurality of environmental sensors, correlating the environmental sensor to the HVAC devices of the plurality of HVAC devices for which a change of the one or more environmental parameters is determined (in 210). The method shown in FIG. 3B may be similar to the method of FIG. 3A and may differentiate in that the method may include creating a schedule to sequentially change a set target HVAC temperature value of one HVAC device and to run the other HVAC devices with unvarying running parameters (in 302B). In the case, that the scheduled time is complete (“Yes” in 308), the method shown in FIG. 3B may include changing the running parameters of the currently controlled HVAC device to predefined (e.g., standard) running parameters (in 310B).

Similar to the correlation of an environmental sensor to the HVAC devices of the plurality of HVAC devices for which a change of the one or more environmental parameters is determined (as described with reference to FIG. 2), the IOT Gateway, which receives the one or more environmental parameters from the environmental sensor and transmits the received one or more environmental parameters to the control device 104, may be correlated with the HVAC devices.

FIG. 4 shows a flow diagram 400 of a method for mapping HVAC devices to environmental sensors according to various embodiments. The method is capable to determine a respective impact of each HVAC device of the plurality of HVAC devices on each environmental sensor of the plurality of environmental sensors. The method shown in flow diagram may similar to the method 200, wherein (in 208 of method 200), each environmental sensor of the plurality of environmental sensors may further detect a temperature gradient value (e.g., a change of a temperature over time, such as a temperature change per minute) while the HVAC device is controlled in accordance with the set target HVAC temperature (in 408). Alternatively, each environmental sensor of the plurality of environmental sensors may continuously detect temperature values and a control device (e.g., the control device 104 in the case of the HVAC system 100) may determine the temperature gradient value using the continuously detected temperature values. After correlating each environmental sensor to the HVAC devices for which a change of the one or more environmental parameters is detected (in 210), the method may include, for each HVAC device of the plurality of HVAC devices, determining a respective weight value for each environmental sensor correlated with the HVAC device (in 412).

The may include, for each HVAC device of the plurality of HVAC devices, determining a respective weight value for each environmental sensor correlated with the HVAC device using the temperature gradient values detected by the environmental sensors correlated with the HVAC device. The weight value associated with an environmental sensor correlated with the HVAC device may be determined as a fraction of the temperature gradient value detected by the environmental sensor from (e.g., out of) all temperature gradient values that are detected by the environmental sensors correlated with the HVAC device. For example, in the case of the HVAC system 100, a weight value W(n, m) associated with a HVAC device 102(n) and an environmental sensor Gm may be determined as a fraction of the temperature gradient value detected by the environmental sensor Gm from all temperature gradient values that are detected by the environmental sensors G(m=1 to M), such as shown in the following equation, wherein Un denotes the HVAC device 102(n):

$$W ( n , m ) = \frac{Tgrad ( Gm , Un )}{{\sum }_{m = 0}^{m = M} Tgrad ( Gm , Un )} .$$

For example, a weight value W(2, 1) associated with the HVAC device 102(1) and an environmental sensor G2 may be determined by

$$W ( 2 , 1 ) = \frac{Tgrad ( G 1 , U 2 )}{{\sum }_{m = 0}^{m = M} Tgrad ( Gm , U 2 )} .$$

Illustratively, the sum of all weight values associated with an environmental sensor may be equal to “1”.

The method may include controlling the HVAC system to change at least one environmental parameter associated with at least one environmental sensor of the plurality of environmental sensors using the HVAC devices correlated with the at least one environmental sensor and their respective weight values determined for the at least one environmental sensor. This may improve the control of the overall HVAC system since environmental parameters in the indoor environment can be adjusted more precisely. According to various aspects, the HVAC system 100 may be configured to carry out the method. In an example based on table 1, the control device 104 may be configured to control at least one environmental parameter (e.g., a temperature) of the environmental sensor G6 using the HVAC devices 102(2), 102(4), and 102(5) correlated with the environmental sensor G6 and their respective weight values W(2, 6), W(4, 6), and W(5, 6) determined for the at least one environmental sensor G6.

As described herein, the HVAC system (e.g., the HVAC system 100) may be or may include a VRF system and/or a chiller system.

FIG. 5A shows an exemplary HVAC system 500 including VRF units as HVAC devices 102(n) and a plurality of environmental sensors Gm. FIG. 6 shows an exemplary HVAC system 600 including chiller units as HVAC devices 102(n) and a plurality of environmental sensors Gm.

FIG. 5B shows an exemplary mapping of HVAC devices to environmental sensors which may be achieved as a result of determining a respective weight value for each environmental sensor correlated with a respective HVAC device (in 412) of the method of FIG. 4. This example of a mapping of HVAC devices to

| | G1 | G2 | G3 | G4 | G5 | G6 |
|---|---|---|---|---|---|---|
| 102(1) | W(1, 1) | W(1, 2) | 0 | 0 | 0 | 0 |
| 102(2) | W(2, 1) | W(2, 2) | 0 | 0 | 0 | W(2, 6) |
| 102(3) | 0 | 0 | W(3, 3) | W(3, 4) | 0 | 0 |
| 102(4) | 0 | W(4, 2) | 0 | 0 | W(4, 5) | W(4, 6) |
| 102(5) | 0 | 0 | 0 | 0 | W(5, 5) | W(5, 6) |

environmental sensors may be based on table 1 and may result in table 2:

The controlling of the HVAC system to change at least one environmental parameter associated with at least one environmental sensor of the plurality of environmental sensors may be carried out using one or more additional information. The additional information may include occupancy information which describe an occupancy of a region (e.g., a zone) in which the HVAC devices correlated with the at least one environmental sensors are located. A number of people occupying a zone may impact, for example, a cooling/heating rate associated with an environmental temperature. The occupancy information may be detected by a plurality of occupancy sensors (e.g., infrared-based, e.g., ultrasonic-based, e.g., microwave-based, etc.). According to various aspects, the HVAC system may include a plurality of IOT Gateways and each IOT Gateway may be associated with an environmental sensor of the plurality of environmental sensors and an occupancy sensor of the plurality of occupancy sensors. The additional information may include a thermal comfort of the people occupying the indoor environment (e.g., using a user-in-the-loop approach, wherein a temperature is controlled in accordance with a personal thermal comfort). According to various aspects,

What is claimed is:

1. A method of controlling a heating, ventilation, and air-conditioning (HVAC) system, the method comprising the following steps:
successively, for each of at least two HVAC devices of a plurality of HVAC devices associated with the HVAC system:
controlling the HVAC device in accordance with a set target HVAC temperature value which is different from an environmental temperature value,
deactivating the other HVAC devices of the plurality of HVAC devices or running the other HVAC devices with unvarying running parameters, and
determining, for at least two environmental sensors of a plurality of environmental sensors, whether one or more environmental parameters detected by the respective environmental sensor change;
correlating, for at least one environmental sensor of the at least two environmental sensors, the at least one environmental sensor to the HVAC devices of the at least two HVAC devices for which a change of the one or more environmental parameters is determined; and
controlling the HVAC system to change at least one environmental parameter associated with the at least one environmental sensor using the HVAC devices of the at least two HVAC devices correlated with the at least one environmental sensor.

2. The method according to claim 1, wherein the running of the other HVAC devices of the plurality of HVAC devices with unvarying running parameters includes maintaining respective running parameters of each of the plurality of HVAC devices constant except for the HVAC device which is controlled to change the environmental temperature.

3. The method according to claim 1, wherein the one or more environmental parameters includes: one or more of a temperature, and/or a humidity and/or a dew point.

4. The method according to claim 1, wherein the HVAC system includes a variable refrigerant flow system and/or a chiller system.

5. The method according to claim 1, wherein the determining of whether the one or more environmental parameters detected by the respective environmental sensor change includes:
detecting, by the environmental sensor, a temperature gradient value while the HVAC device is controlled in accordance with the set target HVAC temperature.

6. The method according to claim 5, further comprising:
determining, for each HVAC device of the at least two HVAC devices, a respective weight value for each environmental sensor correlated with the HVAC device using the temperature gradient values detected by the environmental sensors correlated with the HVAC device.

7. The method according to claim 6, wherein the weight value associated with an environmental sensor correlated with the HVAC device is determined as a fraction of the temperature gradient value detected by the environmental sensor from all temperature gradient values that are detected by the environmental sensors correlated with the HVAC device.

8. The method according to claim 6, wherein the controlling of the HVAC system to change at least one environmental parameter associated with the at least one environmental sensor using the HVAC devices of the at least two HVAC devices correlated with the at least one environmental sensor includes:
controlling the HVAC system to change at least one environmental parameter associated with the at least one environmental sensor using the HVAC devices correlated with the at least one environmental sensor and their respective weight value determined for the at least one environmental sensor.

9. A heating, ventilation, and air-conditioning (HVAC) system, comprising:
a plurality of HVAC devices, wherein each of the plurality of HVAC devices is configured to change an environmental temperature in accordance with a respective set target HVAC temperature;
a plurality of environmental sensors, wherein each of the plurality of environmental sensors is configured to detect one or more environmental parameters; and
a control device configured to control the plurality of HVAC devices and the plurality of environmental sensors and to:
successively, for each of at least two HVAC devices of the plurality of HVAC devices associated with the HVAC system:
control the HVAC device in accordance with a set target HVAC temperature value which is different from an environmental temperature value,
deactivate the other HVAC devices of the plurality of HVAC devices or run the other HVAC devices with unvarying running parameters, and
determine, for at least two environmental sensors of a plurality of environmental sensors, whether one or more environmental parameters detected by the respective environmental sensor change,
correlate, for at least one environmental sensor of the at least two environmental sensors, the at least one environmental sensor to the HVAC devices of the at least two HVAC devices for which a change of the one or more environmental parameters is determined, and
control the HVAC system to change at least one environmental parameter associated with the at least one environmental sensor using the HVAC devices of the at least two HVAC devices correlated with the at least one environmental sensor.

10. The HVAC system according to claim 9, wherein at least one environmental sensor of the plurality of environmental sensors is configured to wirelessly transmit the detected one or more environmental parameters to the control device.
